(19) United States
(12) Patent Application Publication
(10) Pub. No.: US 2026/0061708 A1
(43) Pub. Date: Mar. 5, 2026

(54) INTEGRATED INTELLIGENT WELDING PLATFORM AND WELDING METHOD

(71) Applicant: SOOCHOW UNIVERSITY, Wujiang (CN)

(72) Inventors: Chuanyang Wang, Wujiang (CN); Ning Jiang, Wujiang (CN); Rundong Qian, Wujiang (CN); Yayun Liu, Wujiang (CN); Fanshuo Jia, Wujiang (CN)

(21) Appl. No.: 19/271,118

(22) Filed: Jul. 16, 2025

Related U.S. Application Data
(63) Continuation of application No. PCT/CN2024/144060, filed on Dec. 31, 2024.

(30) Foreign Application Priority Data
Aug. 27, 2024 (CN) 202411183970.X

(51) Int. Cl. B29C 65/00; B29L 31/34

(52) U.S. Cl. CPC B29C 66/95; B29L 2031/34

(57) ABSTRACT

The invention provides an integrated intelligent welding platform and a welding method. The welding platform includes a stretching unit, a welding unit, and a control unit. The stretching unit includes a flatness monitoring component and a stretching component. The stretching component is configured to receive a stretching control signal and apply a stretching force to a flexible electronic skin. The welding unit includes a welding monitoring component and a lifting component. The welding monitoring component is configured to obtain welding information, and the lifting component is configured to receive a welding control signal and apply a compression force to the flexible electronic skin. The control unit includes a first and second control components. The first control component is configured to receive the flatness information and transmit the stretching control signal. The second control component is configured to receive the welding information and transmit the welding control signal.

This application is a Continuation application of PCT/CN2024/144060, filed on Dec. 31, 2024, which claims priority to Chinese Patent Application No. 202411183970.X, filed on Aug. 27, 2024, which is incorporated by reference for all purposes as if fully set forth herein.

### FIELD OF THE INVENTION

The present invention relates to the technical field of intelligent welding platforms, and in particular, to an integrated intelligent welding platform and a welding method.

### DESCRIPTION OF THE RELATED ART

Flexible electronic skin, as a novel intelligent material, has been widely applied in fields such as robotics, medical devices, and wearable devices. However, due to its thin and pliable nature, flexible electronic skin is highly prone to deformation in a manufacturing and processing process.

For example, a product includes a first flexible electronic skin and a second flexible electronic skin, and the skins need to be stacked and welded. In existing technologies, clamps are typically first disposed to fix flexible electronic skins, which are then welded by using a welding device. Due to the thin and pliable nature of flexible electronic skins, during either clamping using clamps or welding using a welding device, flexible electronic skins is prone to non-uniform stretching or torsional deformation, which ultimately leads to defects at welding positions. The defects include weak welding joint, discontinuous weld seams, or cracks in a welding area. These defects compromise skin quality and also cause failures of skins during actual application, resulting in reduced product reliability and service life.

In summary, how to overcome dynamic deformation of a flexible electronic skin in a welding process to ensure the welding quality and consistency of the flexible electronic skin currently becomes an urgent problem to be resolved.

### SUMMARY OF THE INVENTION

For this, a technical problem to be resolved by the present invention is to overcome the difficulty in ensuring welding quality of welding a flexible electronic skin by using an existing welding device, and provide an integrated intelligent welding platform and a welding method, to ensure high welding quality by arranging a stretching unit, a welding unit, and a control unit.

According to a first aspect, the present invention provides an integrated intelligent welding platform used for welding a flexible electronic skin. The flexible electronic skin includes a first flexible electronic skin and a second flexible electronic skin stacked in a first direction. The integrated intelligent welding platform includes: a stretching unit, the stretching unit including a flatness monitoring component and a stretching component, where the flatness monitoring component is configured to obtain flatness information of the flexible electronic skin being stretched, and the stretching component is configured to receive a stretching control signal and apply a stretching force perpendicular to the first direction to the flexible electronic skin; a welding unit, the welding unit including a welding monitoring component and a lifting component, where the welding monitoring component is configured to obtain welding information of the flexible electronic skin being welded, and the lifting component is configured to receive a welding control signal and apply a compression force parallel to the first direction to the flexible electronic skin; and a control unit, the control unit including a first control component and a second control component, where the first control component is electrically connected to both the flatness monitoring component and the stretching component, the first control component is configured to receive the flatness information and transmit the stretching control signal, the second control component is electrically connected to both the welding monitoring component and the lifting component, and the second control component is configured to receive the welding information and transmit the welding control signal.

In an embodiment of the present invention, the stretching control signal includes a first control signal; and the stretching component includes: a first stretching assembly, where the first stretching assembly is disposed on one side of the flexible electronic skin in a second direction, and the first stretching assembly includes a stretching actuator, a first sliding table, a second sliding table, a first clamp, and a tension-compression sensor; the stretching actuator, the first sliding table, and the second sliding table are disposed in sequence in the second direction, the first sliding table is fixedly disposed with respect to the stretching actuator, a through hole is opened on the first sliding table, a drive end of the stretching actuator passes through the through hole of the first sliding table and is connected to the second sliding table in a transmission way, the stretching actuator is electrically connected to the first control component, and the stretching actuator is configured to receive the first control signal and drive the second sliding table to move along the second direction; and the first clamp is disposed on the second sliding table, the first clamp clamps both the first flexible electronic skin and the second flexible electronic skin, two detection ends of the tension-compression sensor are respectively connected to the first sliding table and the second sliding table, and the tension-compression sensor is configured to obtain tension information on the flexible electronic skin; and a second stretching assembly, where the second stretching assembly and the first stretching assembly are respectively disposed at two sides of the flexible electronic skin in the second direction, the second stretching assembly includes a second clamp, and the second clamp clamps both the first flexible electronic skin and the second flexible electronic skin.

In an embodiment of the present invention, the first control component includes: a first comparator, where the first comparator is electrically connected to the flatness monitoring component, and the first comparator is configured to compare first expected flatness information with the flatness information; a second comparator, where the second comparator is electrically connected to the tension-compression sensor, and the second comparator is configured to compare expected tension information with the tension information; and a first regulator, where the first regulator is electrically connected to all the first comparator, the second comparator, and the stretching actuator, and the first regulator transmits the first control signal based on a proportion, integral, and derivative (PID) control algorithm to dynamically adjust the stretching force on the flexible electronic skin, where when the flatness information matches the first expected flatness information and the tension information matches the expected tension information, the first regulator transmits a first stop signal; and the stretching actuator is configured to receive the first stop signal and stop driving the second sliding table to move.

In an embodiment of the present invention, the stretching control signal includes a second control signal; the second clamp includes a first clamping component and a second clamping component, the first clamping component is connected to the first flexible electronic skin, and the second clamping component is connected to the second flexible electronic skin; and the second stretching assembly further includes a first three-axis actuator and a second three-axis actuator that are spaced apart in sequence in the second direction; a drive end of the first three-axis actuator is connected to the first clamping component, and the first three-axis actuator is configured to receive the second control signal and drive the first clamping component to move; and a drive end of the second three-axis actuator is connected to the second clamping component, and the second three-axis actuator is configured to receive the second control signal and drive the second clamping component to move.

In an embodiment of the present invention, the first control component further includes: a third comparator, where the third comparator is electrically connected to the flatness monitoring component, and the third comparator is configured to compare second expected flatness information with the flatness information; and a second regulator, where the second regulator is electrically connected to all the second comparator, the third comparator, the first three-axis actuator, and the second three-axis actuator, and the second regulator is configured to transmit the second control signal to dynamically adjust the flatness information, where when the flatness information matches the second expected flatness information and the tension information matches the expected tension information, the second regulator transmits a second stop signal; and the first three-axis actuator is configured to receive the second stop signal and stop driving the first clamping component to move, and the second three-axis actuator is configured to receive the second stop signal and stop driving the second clamping component to move.

In an embodiment of the present invention, the flatness monitoring component includes: a fringe light emitter, where the fringe light emitter is configured to transmit fringe light to the flexible electronic skin; an image acquisition device, where the image acquisition device is configured to obtain a reflected image of the fringe light on a surface of the flexible electronic skin; and an image processor, where the image processor is electrically connected to both the image acquisition device and the first control component, and the image processor is configured to obtain the flatness information based on the reflected image.

In an embodiment of the present invention, the lifting component includes two lifting assemblies, the two lifting assemblies are respectively disposed in sequence on two sides of the flexible electronic skin in a second direction, each lifting assembly includes a compression device and two compression actuators, the two compression actuators are respectively disposed at two sides of the flexible electronic skin in a third direction, drive ends of the two compression actuators are both connected to the compression device, the compression actuators are electrically connected to the second control component, and the compression actuators are configured to receive the welding control signal and drive the compression devices to move along the first direction.

In an embodiment of the present invention, the welding unit further includes a welding component, and the welding component is configured to receive the welding control signal and weld the first flexible electronic skin and the second flexible electronic skin.

In an embodiment of the present invention, the second control component transmits the welding control signal based on an artificial neural network (ANN) model integrating a crow-wolf optimization (CWO) algorithm.

According to a second aspect, the present invention further provides a welding method based on any foregoing integrated intelligent welding platform, including the following steps:
S1. applying the stretching force perpendicular to the first direction to the flexible electronic skin through the stretching unit; and
S2. welding the flexible electronic skin, where the compression force parallel to the first direction is applied to the flexible electronic skin through the welding unit.

Compared with existing technologies, the foregoing technical solutions of the present invention have the following beneficial effects:

In one aspect, the integrated intelligent welding platform of the present invention integrates the flatness monitoring component and the stretching component to achieve flat stretching of a flexible electronic skin before welding. In a stretching process, the flatness monitoring component obtains flatness information of the flexible electronic skin to monitor and adjust a stretching force on the flexible electronic skin, and has higher precision and frequency than conventional tension monitoring. It can be ensured that the stretched flexible electronic skin has precise flatness to facilitate subsequent welding, thereby preparing for high-quality welding. In another aspect, the welding monitoring component and the lifting component are integrated to achieve clamping regulation of a weld seam width of flexible electronic skins and a gap size between two skins in the welding process. In the welding process, the welding monitoring component obtains the weld seam width of flexible electronic skins and the gap size between two skins, thereby facilitating real-time regulation of the lifting component. The stability in a welding process and product quality after welding can be ensured, thereby reducing welding defects, and ensuring product reliability and durability. In addition, it is not necessary to spend extra time and costs to rectify or re-manufacture impacted products, thereby reducing the production cycle and costs.

### BRIEF DESCRIPTION OF THE DRAWINGS

To make the content of the present invention clearer and more comprehensible, the present invention is further described in detail below according to specific embodiments of the present invention and the accompanying draws. Where:

FIG. 1 is a schematic structural diagram of an integrated intelligent welding platform from a first perspective according to a preferred embodiment of the present invention;

FIG. 2 is a schematic structural diagram of an integrated intelligent welding platform from a second perspective according to a preferred embodiment of the present invention;

FIG. 3 is a schematic structural diagram of an integrated intelligent welding platform from a third perspective according to a preferred embodiment of the present invention;

FIG. 4 is a schematic structural diagram of a first stretching assembly according to a preferred embodiment of the present invention;

FIG. 5 is a schematic structural diagram of a second stretching assembly according to a preferred embodiment of the present invention; and

FIG. 6 is a schematic structural diagram of a lifting component according to a preferred embodiment of the present invention.

Reference numerals in the specification: D1. first direction; D2. second direction; D3. third direction; 11. first flexible electronic skin; 12. second flexible electronic skin; 21. first image acquisition device; 22. second image acquisition device; 23. stretching component; 231. first stretching assembly; 2311. stretching actuator; 2312. first sliding table; 2313. second sliding table; 2314. first clamp; 2315. tension-compression sensor; 232. second stretching assembly; 2321. first clamping component; 2322. second clamping component; 2323. first three-axis actuator; 2324. second three-axis actuator; 30. lifting component; 31. lifting assembly; 311. compression device; and 312. compression actuator.

### DETAILED DESCRIPTION OF THE PREFERRED EMBODIMENTS

The present invention is further described below with reference to the accompanying drawings and specific embodiments, to enable a person skilled in the art to better understand and implement the present invention. However, the embodiments are not used to limit the present invention.

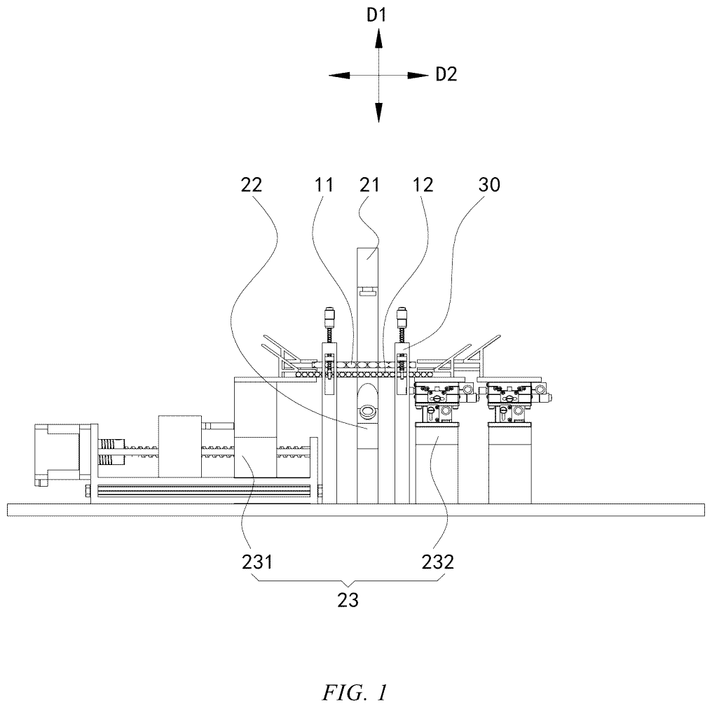

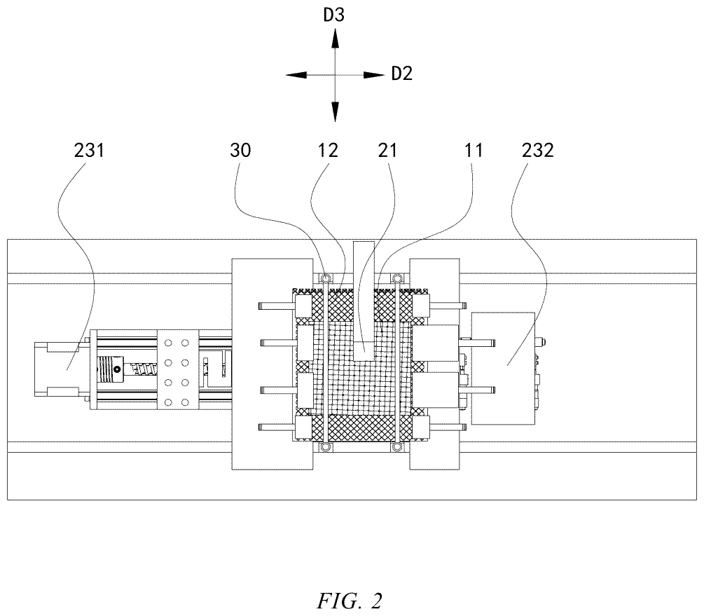

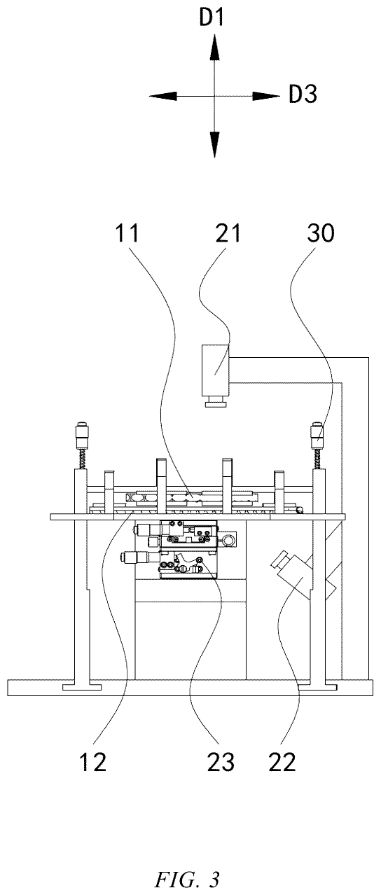

Referring to FIG. 1 to FIG. 3, the present invention provides an integrated intelligent welding platform used for welding a flexible electronic skin. The flexible electronic skin includes a first flexible electronic skin 11 and a second flexible electronic skin 12 stacked in a first direction D1. In this embodiment, the first direction D1 is parallel to a thickness direction of the flexible electronic skin. The integrated intelligent welding platform includes a stretching unit, a welding unit, and a control unit.

Specifically, the stretching unit includes a flatness monitoring component and a stretching component 23. The flatness monitoring component is configured to obtain flatness information of the flexible electronic skin being stretched. The flatness monitoring component can be disposed by a person skilled in the art according to an actual requirement, provided that the flatness information can be obtained. In this embodiment, the flatness information of the flexible electronic skin is surface flatness of the flexible electronic skin, and is represented by peak-to-valley (PV) precision. The flatness monitoring component is disposed, so that the flatness information of the flexible electronic skin in a stretching process can be obtained, to achieve monitoring of a stretching force on the flexible electronic skin, thereby making a corresponding force adjustment to achieve high precision and high frequency.

The stretching component 23 is configured to receive a stretching control signal and apply a stretching force perpendicular to the first direction D1 to the flexible electronic skin. A specific stretching component 23 can be disposed by a person skilled in the art according to an actual requirement to adapt to the first flexible electronic skin 11 and the second flexible electronic skin 12 that are stacked. The control unit includes a first control component. The first control component is electrically connected to both the flatness monitoring component and the stretching component 23. The first control component is configured to receive the flatness information and transmit the stretching control signal.

Before welding, the first flexible electronic skin 11 and the second flexible electronic skin 12 that are stacked are first stretched by using the stretching component 23, to enable the two to be stably and uniformly stretched. It can be ensured that the stretched flexible electronic skin has precise flatness to facilitate subsequent welding, thereby preparing for high-quality welding.

The welding unit includes a welding monitoring component and a lifting component 30. The welding monitoring component is configured to obtain welding information of the flexible electronic skin being welded. The welding monitoring component can be disposed by a person skilled in the art can according to an actual requirement, provided that the welding information can be obtained. In this embodiment, the welding information includes at least a weld seam width and a gap size between two skins. The welding monitoring component is disposed, so that the weld seam width of flexible electronic skins and a gap size between two skins in a welding process can be obtained, thereby making a corresponding adjustment to the compression force to adjust the weld seam width and the gap size between skins and achieve high precision and a good effect.

The lifting component 30 is configured to receive a welding control signal and apply a compression force parallel to the first direction D1 to the flexible electronic skin. A specific lifting component 30 can be disposed by a person skilled in the art according to an actual requirement to adapt to the first flexible electronic skin 11 and the second flexible electronic skin 12 that are stacked. The control unit includes a second control component. The second control component is electrically connected to both the welding monitoring component and the lifting component 30. The second control component is configured to receive the welding information and transmit the welding control signal.

During welding after stretching is completed, the first flexible electronic skin 11 and the second flexible electronic skin 12 that are stacked are clamped by using the welding monitoring component in cooperation with the lifting component 30 to adjust the weld seam width between the two and the gap size between two skins. Deformation problems in the welding process of the flexible electronic skin are effectively mitigated, thereby improving welding quality.

In one aspect, the integrated intelligent welding platform of the present invention integrates the flatness monitoring component and the stretching component 23 to achieve flat stretching of a flexible electronic skin before welding. In the stretching process, the flatness monitoring component obtains flatness information of the flexible electronic skin to monitor and adjust a stretching force on the flexible electronic skin, and has higher precision and frequency than conventional tension monitoring. It can be ensured that the stretched flexible electronic skin has precise flatness to facilitate subsequent welding, thereby preparing for high-quality welding. In another aspect, the welding monitoring component and the lifting component 30 are integrated to achieve clamping regulation of a weld seam width of flexible electronic skins and a gap size between two skins in the welding process. In the welding process, the welding monitoring component obtains the weld seam width of flexible electronic skins and the gap size between two skins, thereby facilitating real-time regulation of the lifting component 30. The stability in the welding process and product quality after welding can be ensured, thereby reducing welding defects, and ensuring product reliability and durability. In addition, it is not necessary to spend extra time and costs to rectify or re-manufacture impacted products, thereby reducing the production cycle and costs.

Referring to FIG. 1, for the integrated intelligent welding platform of the present invention, in some embodiments, the flatness monitoring component includes a fringe light emitter, an image acquisition device, and an image processor.

Specifically, the fringe light emitter is configured to transmit fringe light to the flexible electronic skin. Preferably, the fringe light emitter is disposed as a laser interferometer that can emit a parallel fringe beam. The laser interferometer belongs to existing technologies. The laser interferometer uses a laser light source and a grating to generate a fringe pattern on the surface of the flexible electronic skin. Preferably, two fringe light emitters are provided to emit fringe light to the first flexible electronic skin 11 and the second flexible electronic skin 12 respectively.

The image acquisition device is configured to obtain a reflected image of the fringe light on a surface of the flexible electronic skin. Preferably, the image acquisition device includes a first image acquisition device 21 and a second image acquisition device 22. The first image acquisition device 21 is configured to acquire a reflected image on a surface on a side of the first flexible electronic skin 11 that is away from the second flexible electronic skin 12 in the first direction D1. The second image acquisition device 22 is configured to acquire a reflected image on a surface on a side of the second flexible electronic skin 12 that is away from the first flexible electronic skin 11 in the first direction D1. Preferably, both the first image acquisition device 21 and the second image acquisition device 22 are disposed as 10-megapixel cameras, and a bracket is disposed for fixation.

The image processor is electrically connected to both the image acquisition device and the first control component to transmit data information. The image processor is configured to obtain flatness information according to a reflected image. After a corresponding image acquisition device obtains an image, the image processor processes the image, analyzes fringe deformation, and calculates flatness information on a surface of a corresponding flexible electronic skin. Subsequently, the flatness information is delivered to the first control component, making it convenient for the first control component to adjust, based on the flatness information, a stretching force that is on the flexible electronic skin and is perpendicular to the first direction D1. Preferably, the PV precision during monitoring is set to 50 nm. The structure is arranged, so that it is ensured that the stretching force falls within a set range, and the flatness of the surface can also be ensured, thereby improving the precision and consistency of a stretching process.

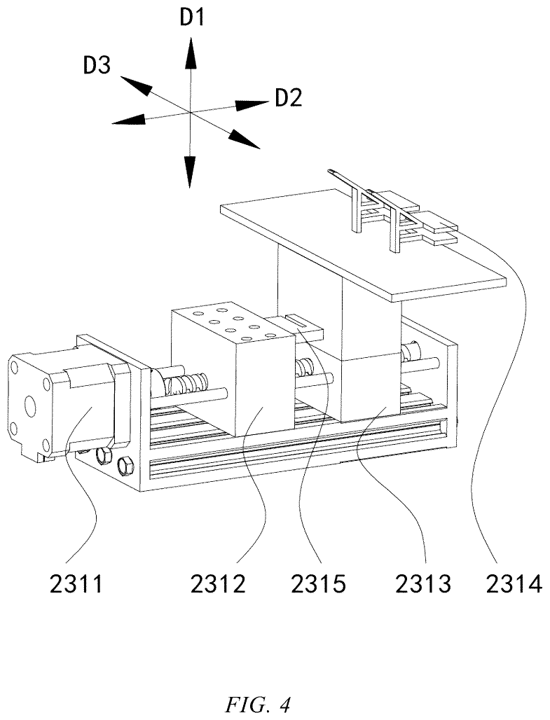

Referring to FIG. 1 and FIG. 4, for the integrated intelligent welding platform of the present invention, in some embodiments, the stretching control signal includes a first control signal. The stretching component 23 includes a first stretching assembly 231 and a second stretching assembly 232, to fix and stretch the flexible electronic skin.

Specifically, the first stretching assembly 231 is disposed on one side of the flexible electronic skin in a second direction D2. The second direction D2 and the first direction D1 are perpendicular to each other. The first stretching assembly 231 includes a stretching actuator 2311, a first sliding table 2312, a second sliding table 2313, a first clamp 2314, and a tension-compression sensor 2315. The stretching actuator 2311, the first sliding table 2312, and the second sliding table 2313 are disposed in sequence in the second direction D2. The first sliding table 2312 is fixedly disposed with respect to the stretching actuator 2311. Preferably, when stretching is not performed, a position relationship between the two can be relatively adjusted to stretch different products. During stretching, the two are fixed with respect to each other to use the first sliding table 2312 as a fixation reference. A specific manner of implementing the structure can be set by a person skilled in the art according to an actual requirement. For example, a strip-shaped hole is provided to cooperate with a nut and a bolt to lock or loosen the first sliding table 2312. A through hole is opened on the first sliding table 2312. The through hole is not shown in the figure.

A drive end of the stretching actuator 2311 passes through the through hole in the first sliding table 2312 and is connected to the second sliding table 2313 in a transmission way. The stretching actuator 2311 is electrically connected to the first control component, and the stretching actuator 2311 is configured to receive the first control signal and drive the second sliding table 2313 to move along the second direction D2. The first clamp 2314 is disposed on the second sliding table 2313, and the first clamp 2314 clamps both the first flexible electronic skin 11 and the second flexible electronic skin 12.

A specific stretching actuator 2311 can be disposed by a person skilled in the art according to an actual requirement. Preferably, a combination of a servo motor and a ball screw is disposed. During use, the servo motor drives the ball screw to rotate to drive the second sliding table 2313 to slide with respect to the servo motor. Preferably, an adjustable speed range of the servo motor is set to 5 mm/s to 20 mm/s, and rotation precision is set to 0.01° to 0.1°, so that stable stretching can be ensured, and an excessively fast or excessively slow start speed is avoided to prevent non-uniform force bearing of a product or unnecessary stress, thereby ensuring a good stretching effect, avoiding damage to a product, and laying a solid foundation for subsequent operations. Compared with other transmission manners, for example, belt transmission or chain transmission, ball screw transmission has good precision and stability, so that the movement speed and the position of the second sliding table 2313 can be accurately controlled, thereby ensuring that uniform tension is applied on the flexible electronic skin. The tension applied to the flexible electronic skin in the stretching process needs to be kept uniform. In this way, it can be ensured that the product bears uniform stress distribution through the stretching process, thereby avoiding product damage or inadequate stretching due to non-uniform tension. The ball screw transmission can precisely control the movement of the second sliding table 2313 and the first clamp 2314, thereby ensuring that tension applied in the stretching process remains at a stable and uniform level, so that the entire platform can keep a stable and reliable operating state in the stretching process, and the position and speed of the second sliding table 2313 can be accurately controlled. The ball screw transmission has advantages such as high transmission efficiency, long service life, and high feedback precision, so that the stability and reliability of the system in the stretching process can be kept. The control precision and stability in the stretching process are improved, and the ball screw transmission is conducive to improving production efficiency and stretching quality, thereby ensuring that the flexible electronic skin can meet expected stretching requirements and keeping good product quality.

Two detection ends of the tension-compression sensor 2315 are respectively connected to the first sliding table 2312 and the second sliding table 2313. The tension-compression sensor 2315 is configured to obtain tension information on the flexible electronic skin. Preferably, the tension-compression sensor 2315 selects an S type, and has flexibility meeting 1.0±2.0 MV/V. The tension information includes tension, pressure or stress on the flexible electronic skin. The structure is disposed, so that in one aspect, a tension test can be implemented; and in another aspect, the tension-compression sensor 2315 can approach an object under test to the greatest extent to reduce interference of external factors, so that tension changes in the flexible electronic skin in the stretching process can be accurately sensed, thereby improving the precision and accuracy of monitoring.

The second stretching assembly 232 and the first stretching assembly 231 are respectively disposed at two sides of the flexible electronic skin in the second direction D2. The second stretching assembly 232 includes a second clamp. The second clamp clamps both the first flexible electronic skin 11 and the second flexible electronic skin 12. In the stretching process, the first clamp 2314 and the second clamp cooperate with each other to achieve clamping and fixation of the flexible electronic skin, thereby ensuring that the skin can keep a stable position and posture throughout the stretching process, and preventing movement or shaking from affecting the accuracy and consistency of stretching. In addition, the fixation of the skin can further reduce the operation difficulty for an operator, thereby improving the operating efficiency. The second stretching assembly 232 can be disposed by a person skilled in the art according to an actual requirement. For example, the second clamp is fixedly disposed, or a three-axis actuator is disposed to drive the corresponding second clamp to move.

Further, for the integrated intelligent welding platform of the present invention, in some embodiments, the first control component includes a first comparator, a second comparator, and a first regulator.

The first comparator is electrically connected to the flatness monitoring component. The first comparator is configured to compare first expected flatness information with the flatness information. The first expected flatness information is a preset known quantity, and may be set by a person skilled in the art according to an actual requirement. For example, the first expected flatness information is set to that a surface PV value is less than 20 μm. The flatness information is obtained by the flatness monitoring component.

The second comparator is electrically connected to the tension-compression sensor 2315. The second comparator is configured to compare expected tension information with the tension information. The expected tension information is also a preset known quantity, and may be set by a person skilled in the art according to an actual requirement. For example, the expected tension information is set to that the tension is greater than or equal to 50 N. Preferably, the second comparator and the tension-compression sensor 2315 are connected by a data acquisition device. The data acquisition device converts an acquired analog signal into a digital signal, and transfers the digital signal to the second comparator, thereby ensuring that the transmission stability and reliability of the acquired data. The transmission of digital signals is not susceptible to interference. Such a conversion and transmission process can ensure that tension information data acquired by the tension-compression sensor 2315 is accurately transmitted to the second comparator to provide a reliable data foundation for subsequent data processing and analysis. The tension-compression sensor 2315 is disposed to monitor tension changes in the flexible electronic skin in the stretching process in real time, and transmits acquired data to the second comparator in real time, so that the real-time control and adjustment of the stretching process can be implemented. This real-time feedback mechanism can enable the first control component to learn changes in tension in time, so that timely adjustment and control can be made according to an actual case. In this way, it can be ensured that the flexible electronic skin remains in a preset tension range in the stretching process, thereby avoiding product damage or inadequate stretching due to excessively large or excessively small tension, improving the stretching quality and stability of a product, and reducing waste and loss in a production process.

The first regulator is electrically connected to all the first comparator, the second comparator, and the stretching actuator 2311. The first regulator transmits the first control signal based on a PID (Proportion, Integral, Differential) control algorithm to dynamically adjust the stretching force on the flexible electronic skin, thereby ensuring sufficient tension, and achieving optimal stretching of the skin. The PID control algorithm includes a proportional term, an integral term, and a derivative term, which are all responsible for dynamically adjusting the first stretching assembly 231 based on a current status and a historical status, thereby achieving precise control and stable regulation of the stretching process. Specifically, the proportional term adjusts an output based on a difference between current tension information and the expected tension information. When the value of tension deviates from the value of expected tension, the proportional term generates a correction quantity proportional to a deviation to regulate the first stretching assembly 231 toward the value of the expected tension, thereby achieving the precise control of tension. The integral term is responsible for accumulating historical deviations, and eliminating steady-state errors by regulating the response speed of the first stretching assembly 231. The integral term can adjust the output of the first stretching assembly 231 by accumulating deviations within a past period of time to eliminate continuous deviations caused by inherent characteristics or external interference of the first stretching assembly 231, thereby ensuring that the first stretching assembly 231 is stable near the value of the expected tension. The derivative term predicts a future error change trend based on an error change speed, thereby improving the dynamic response characteristics of the first stretching assembly 231. The derivative term can regulate a change range of errors to reduce the overshoot and oscillation phenomena of the first stretching assembly 231, thereby improving the response speed and stability of the first stretching assembly 231.

The structure is disposed, so that the first control component can keep comparing actual values and expected values of flatness and tension to obtain differences. If it is detected that flatness or tension deviates from an expected value, real-time correction is performed based on adjustment results of a proportional term, an integral term, and a derivative term through a PID control algorithm. For example, when an increase in tension leads to reduced flatness of a product, the first control component reduces the speed of the servo motor to reduce the tension. In contrast, when the flatness increases but the tension is insufficient, the speed of the servo motor is increased to increase the tension. The stretching quality of a skin is improved, thereby ensuring that the skin meets design requirements. Such dynamic adjustment can effectively deal with external environmental changes and internal fluctuations, thereby ensuring the stability and controllability of the stretching process. Preferably, the first control component is electrically connected to a display to display processed data on an operation interface of the display for monitoring and analysis by an operator. Preferably, tension data acquired in real time is displayed on an interface in the form of a chart, a curve, or the like, to enable the operator to clearly learn a change trend of tension and an operating status of a platform, find and solve potential problems in time, and ensure a smooth stretching process.

When the flatness information matches the first expected flatness information and the tension information matches the expected tension information, the first regulator transmits a first stop signal. The stretching actuator 2311 is configured to receive the first stop signal and stop driving the second sliding table 2313 to move. For example, when the flatness information is 18 μm and the expected tension information is 51 N, in this case, the flatness information matches the first expected flatness information, and the tension information matches the expected tension information. The first regulator transmits a first stop signal to stop stretching. The structure is disposed, so that it can be ensured that stretching stops immediately when a skin reaches a required stretching degree, to avoid product damage or performance degradation caused by excessive stretching. The accuracy and reliability of the stretching process are improved, and the flexible electronic skin is effectively protected from damage caused by excessive stress, thereby extending the service life of the product and ensuring the reliability and stability of the product. In addition, resources and costs can further be saved, and the scrap rate can be minimized, thereby improving the production efficiency and the running stability of a production line.

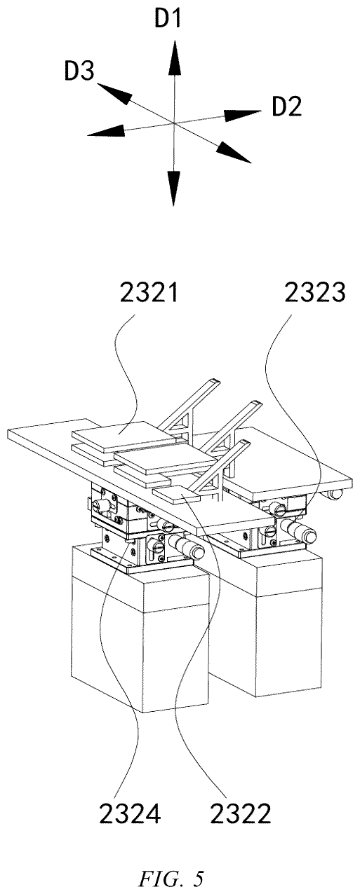

Further, referring to FIG. 1 and FIG. 5, for the integrated intelligent welding platform of the present invention, in some embodiments, the stretching control signal includes a second control signal. The second clamp includes a first clamping component 2321 and a second clamping component 2322, the first clamping component 2321 is connected to the first flexible electronic skin 11, and the second clamping component 2322 is connected to the second flexible electronic skin 12. The second stretching assembly 232 further includes a first three-axis actuator 2323 and a second three-axis actuator 2324 that are spaced apart in sequence in the second direction D2. A drive end of the first three-axis actuator 2323 is connected to the first clamping component 2321, and the first three-axis actuator 2323 is configured to receive the second control signal and drive the first clamping component 2321 to move. A drive end of the second three-axis actuator 2324 is connected to the second clamping component 2322, and the second three-axis actuator 2324 is configured to receive the second control signal and drive the second clamping component 2322 to move. Both the drive ends of the first three-axis actuator 2323 and the second three-axis actuator 2324 are movable along the first direction D1, the second direction D2, and the third direction D3. The third direction D3 is perpendicular to the first direction D1 and the second direction D2. Preferably, the precision of the two three-axis actuators is set to 0.02 mm.

The structure is disposed, so that compared with a combination of a servo motor and a leading screw, the three-axis actuators have higher precision and stability and more degrees of freedom, and can adapt to complex and variable curling forms of flexible electronic skins. The movement speeds and positions of the three-axis actuators can be accurately controlled, thereby ensuring stable and uniform stretching of a flexible electronic skin. It can be ensured that the product bears uniform stress distribution through the stretching process, thereby avoiding product damage or inadequate stretching due to non-uniform stretching. The platform can keep a stable and reliable operating state in the stretching process, so that it is ensured that the platform can accurately control the position and speed of the second stretching assembly 232.

Further, for the integrated intelligent welding platform of the present invention, in some embodiments, the first control component further includes a third comparator and a second regulator.

The third comparator is electrically connected to the flatness monitoring component. The third comparator is configured to compare second expected flatness information with the flatness information. The second expected flatness information is a preset known quantity, has a smaller range compared with the first expected flatness information, and may set by a person skilled in the art according to an actual requirement. For example, the second expected flatness information is set to that the surface PV value is less than 10 μm. The flatness information is obtained by the flatness monitoring component.

The second regulator is electrically connected to all the second comparator, the third comparator, the first three-axis actuator 2323, and the second three-axis actuator 2324, and the second regulator is configured to transmit the second control signal to dynamically adjust the flatness information. Preferably, the second regulator processes, through a deep learning model using a convolutional neural network (CNN) and a long short-term memory network (LSTM), the flatness information transmitted by the image processor to plan optimal movement routes of the three-axis actuators and evaluate the flatness of the current surface, so that the flexible electronic skin is further carefully stretched, thereby ensuring high-quality flatness and improving production efficiency.

Specifically, after receiving the flatness information from the image processor, the first control component performs dynamic adjustment based on a preset control algorithm. A deep learning model is constructed by using a CNN and an LSTM to achieve the precise control and stable regulation of the second stretching assembly 232. The flatness information of the flexible electronic skin is inputted into the CNN according to a time sequence to extract feature information, and a plurality of convolution layers, pooling layers, and fully connected layers are used for implementation. The extracted feature information that contains the time sequence of the CNN is inputted into the LSTM to generate corresponding stretching process control parameters, that is, the second control signal, and the three-axis actuators move based on the second control signal.

Preferably, model training and evaluation are required before use, and a particular amount of image data and corresponding control parameters are collected to train and evaluate the deep learning model. In a use process, a stretching status of a product in the process is monitored in real time, and a difference between an actual effect and a predicted effect is measured. When the difference is greater than a threshold, current new flatness information and control parameters are added as data for training the deep learning model to perform training again, thereby improving the response speed and stability of the system. A virtual model of the stretching process is created by using a digital twin technology. A movement adjustment predicted by the deep learning model is first tested in simulation. If the adjustment is correct, the predicted movement is implemented in the real object. In an implementation process, new flatness information is used as the basis for determination. When a difference between a movement effect and a predicted effect is greater than a threshold, the first control component stops in time. The deep learning model undergoes retraining based on the flatness information, thereby giving control parameters again.

When the flatness information matches the second expected flatness information and the tension information matches the expected tension information, the second regulator transmits a second stop signal. The first three-axis actuator 2323 is configured to receive the second stop signal and stop driving the first clamping component 2321 to move. The second three-axis actuator 2324 is configured to receive the second stop signal and stop driving the second clamping component 2322 to move. For example, when the flatness information is 9 μm and the second expected tension information is 51 N, in this case, the flatness information matches the second expected flatness information, and the tension information matches the expected tension information. The second regulator transmits a second stop signal to stop stretching. The structure is disposed, so that it can be ensured that stretching stops immediately when a skin reaches a required stretching degree, to avoid product damage or performance degradation caused by excessive stretching. The accuracy and reliability of the stretching process are improved, and the flexible electronic skin is effectively protected from damage caused by excessive stress, thereby extending the service life of the product and ensuring the reliability and stability of the product. In addition, resources and costs can further be saved, and the scrap rate can be minimized, thereby improving the production efficiency and the running stability of a production line.

Before actual welding, first, the first flexible electronic skin 11 and the second flexible electronic skin 12 are fixed through corresponding clamps. Next, the parts such as the tension-compression sensor 2315, the stretching actuator 2311, and the three-axis actuator are calibrated. After the calibration, the fringe light emitter emits fringe light to the flexible electronic skin, the image acquisition device obtains a reflected image of the skin, the reflected image is processed by the image processor, and the first regulator transmits the first control signal. After receiving the first control signal, the stretching actuator 2311 drives the second sliding table 2313 to move, to stretch the flexible electronic skin. In the stretching process, the parts such as the image acquisition device, the tension-compression sensor 2315, and the first control component cooperate to perform real-time detection and adjustment of the flatness and tension of the skin. When the flatness information matches the first expected flatness information and the tension information matches the expected tension information, the first regulator transmits the first stop signal. The stretching actuator 2311 stops stretching.

Subsequently, the second regulator transmits the second control signal, to enable the two three-axis actuators to drive the corresponding clamping components to move, thereby achieving further careful stretching of the two flexible electronic skins. In the stretching process, the parts such as the image acquisition device and the first control component cooperate to perform detection and adjustment of the flatness and tension of the skin. When the flatness information matches the second expected flatness information and the tension information matches the expected tension information, the second regulator transmits the second stop signal, and the three-axis actuators stop stretching. Through stepwise stretching, it can be ensured that the flexible electronic skin has high-precision flatness before and after stretching, thereby laying a solid foundation for stretching.

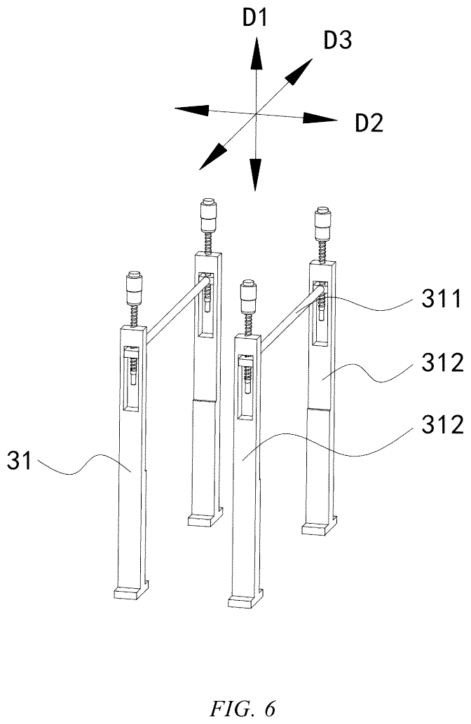

Referring to FIG. 1 and FIG. 6, for the integrated intelligent welding platform of the present invention, in some embodiments, the welding control signal includes a third control signal. The lifting component 30 includes two lifting assemblies 31. The two lifting assemblies 31 are respectively disposed in sequence on two sides of the flexible electronic skin in the second direction D2. Each lifting assembly 31 includes a compression device 311 and two compression actuators 312. The two compression actuators 312 are respectively disposed on two sides of the flexible electronic skin in the third direction D3. A specific compression actuator 312 can be disposed by a person skilled in the art according to an actual requirement. Preferably, a combination of a bracket, a screw rod, and a motor is disposed. Drive ends of the two compression actuators 312 are both connected to the compression device 311. The compression actuators 312 are electrically connected to the second control component, and the compression actuators 312 are configured to receive the third control signal and drive the compression devices 311 to move along the first direction D1, so that the compression device 311 are relatively close to or relatively far away from the flexible electronic skin, to adjust the compression force applied by the compression device 311 to the flexible electronic skin, thereby achieving the regulation of the weld seam width of flexible electronic skins and the gap size between two skins. A specific welding monitoring component can be disposed by a person skilled in the art according to an actual requirement to obtain the weld seam width of flexible electronic skins and the gap size between two skins. Preferably, the image acquisition device of the flatness monitoring component is used as the welding monitoring component to obtain the weld seam width and the gap size between two skins, thereby balancing between costs and space utilization. Subsequently, the image processor processes a corresponding image, obtains the weld seam width and the gap size, and enables the second control component to transmit the third control signal.

For the integrated intelligent welding platform of the present invention, in some embodiments, the welding control signal includes a fourth control signal. The welding unit further includes a welding component, and the welding component is configured to receive the fourth control signal and weld the first flexible electronic skin 11 and the second flexible electronic skin 12. The welding information further includes a welding power, a welding speed, and a temperature at a weld seam of the welding component. A specific manner of obtaining the foregoing welding information can be set by a person skilled in the art according to an actual requirement. For example, an infrared thermographic camera is disposed to obtain temperature information at the weld seam. The infrared thermographic camera is not shown in the figure. After the foregoing welding information is obtained, the second control component transmits the fourth control signal, to adjust the corresponding welding power, welding speed, and temperature at the weld seam, thereby ensuring weld seam quality.

The second control component transmits the welding control signal based on an ANN model integrating a CWO algorithm. A deep learning model is constructed by using a CWO algorithm in combination with an ANN to achieve the precise control and stable regulation of the lifting component 30. The CWO algorithm is an optimized algorithm of the welding status by using a gray wolf optimization (GWO) algorithm, so that the precision of the ANN model can be improved. In some embodiments, a deep learning model may be constructed by choosing a GWO algorithm in communication with an ANN to achieve a similar effect, thereby transmitting the welding control signal. The welding power, the welding speed, and the temperature at the weld seam of the welding component and the gap size between skins are inputted into the model to obtain a predicted weld seam width to obtain a nonlinear relationship between the welding power, the welding speed, the temperature, the gap size, and the weld seam width, and then the current welding power, the welding speed, the gap size, and the temperature are adjusted based on the target weld seam width. The following steps are included:

Parameters of the CWO algorithm are initialized. The parameters include the number of iterations, population size, and dimensionality of optimization variables.

Current welding information is measured. The welding information includes the welding power, the welding speed, the weld seam width, the temperature, and the gap size, to obtain first welding information.

The positions of crows and wolves are initialized, and a data set of the first welding information is fed into the model for training, to obtain an ANN model that has optimal prediction precision and integrates the crow-wolf algorithm.

The welding power, the welding speed, the temperature, and the gap size are initialized, an ideal weld seam width is defined, and the ANN model integrating the CWO algorithm adjusts the initialized parameters based on the ideal weld seam width, to obtain an actual weld seam width. The ideal weld seam width and the actual weld seam width are compared. When a difference meets a threshold, it indicates that running succeeds, and actual welding information is obtained. When the difference exceeds the threshold, the model is retrained based on the current initialized parameters to obtain a new ANN model that has optimal prediction precision and integrates the crow-wolf algorithm, thereby improving the response speed and stability of the system. This process is repeated until the error meets a threshold. In this case, the second control component transmits the welding control signal based on the actual welding information.

For example, in a regulation and control process, product burn-through may be caused by an excessively high laser power or an excessively slow welding speed. To avoid this case, a welding temperature threshold is set for the welding temperature. When the welding temperature measured by the infrared thermographic camera reaches the welding temperature threshold, the welding power is reduced, the welding speed is increased, and laser energy deposition per unit area is reduced. In this case, the weld seam width may continue to be increased by regulating the gap size.

When the weld seam is narrow, the weld seam width may be increased by increasing the welding power, reducing the welding speed or reducing the gap size. When the weld seam is excessively wide, the weld seam width may be reduced by reducing the welding power, increasing the welding speed or increasing the gap size. In this way, welding quality and stability in a welding process can be ensured, to achieve visual monitoring of a weld seam width and automatic adjustment of corresponding parameters, thereby reducing the risk of defects in welding.

The present invention discloses a welding method based on the integrated intelligent welding platform in any foregoing embodiment. The welding method includes the following steps:

S1. Apply the stretching force perpendicular to the first direction D1 to the flexible electronic skin through the stretching unit.

S2. Weld the flexible electronic skin, where the compression force parallel to the first direction D1 is applied to the flexible electronic skin through the welding unit.

### Working Principle:

Before actual welding, first, the first flexible electronic skin 11 and the second flexible electronic skin 12 are fixed through corresponding clamps. Next, the parts such as the tension-compression sensor 2315, the stretching actuator 2311, and the three-axis actuator are calibrated, and the image acquisition device and the infrared thermographic camera are aligned with corresponding positions of the skin. The deep learning model is trained and evaluated before use.

Subsequently, the fringe light emitter emits fringe light to the flexible electronic skin, the image acquisition device obtains a reflected image of the skin, the reflected image is processed by the image processor, and the first regulator transmits the first control signal. After receiving the first control signal, the stretching actuator 2311 drives the second sliding table 2313 to move, to stretch the flexible electronic skin. In the stretching process, the parts such as the image acquisition device, the tension-compression sensor 2315, and the first control component cooperate to perform real-time detection and adjustment of the flatness and tension of the skin. When the flatness information matches the first expected flatness information and the tension information matches the expected tension information, the first regulator transmits the first stop signal. The stretching actuator 2311 stops stretching.

Next, the second regulator transmits the second control signal, to enable the two three-axis actuators to drive the corresponding clamping components to move, thereby achieving further careful stretching of the two flexible electronic skins. In the stretching process, the parts such as the image acquisition device and the first control component cooperate to perform detection and adjustment of the flatness and tension of the skin. When the flatness information matches the second expected flatness information and the tension information matches the expected tension information, the second regulator transmits the second stop signal, and the three-axis actuators stop stretching.

After the stretching is completed, welding is performed. The welding information is measured by using the image acquisition device, the infrared thermographic camera, and the like, and the welding information is inputted into the deep learning model constructed by using the ANN integrating the CWO algorithm, so that the second control component transmits the welding control signal. The lifting component 30, the welding component, and the like receive the signal and achieve the adjustment of parameters such as the welding power, the welding speed, and the temperature at the weld seam, thereby achieving welding and reducing the risk of defects in welding.

The welding is completed, or if irreparable welding defects such as burn-through and breakage are detected in welding, the welding is stopped.

Obviously, the foregoing embodiments are merely examples for clear description, rather than a limitation to implementations. For a person of ordinary skill in the art, other changes or variations in different forms may also be made based on the foregoing description. All implementations cannot and do not need to be exhaustively listed herein. Obvious changes or variations that are derived therefrom still fall within the protection scope of the invention of the present invention.

What is claimed is:

1. An integrated intelligent welding platform, for welding a flexible electronic skin, the flexible electronic skin comprising a first flexible electronic skin and a second flexible electronic skin stacked in a first direction, wherein the integrated intelligent welding platform comprises:
a stretching unit, the stretching unit comprising a flatness monitoring component and a stretching component, wherein the flatness monitoring component is configured to obtain flatness information of the flexible electronic skin being stretched, and the stretching component is configured to receive a stretching control signal and apply a stretching force perpendicular to the first direction to the flexible electronic skin;
a welding unit, the welding unit comprising a welding monitoring component and a lifting component, wherein the welding monitoring component is configured to obtain welding information of the flexible electronic skin being welded, and the lifting component is configured to receive a welding control signal and apply a compression force parallel to the first direction to the flexible electronic skin; and
a control unit, the control unit comprising a first control component and a second control component, wherein the first control component is electrically connected to the flatness monitoring component and the stretching component, the first control component is configured to receive the flatness information and transmit the stretching control signal, the second control component is electrically connected to the welding monitoring component and the lifting component, and the second control component is configured to receive the welding information and transmit the welding control signal.

2. The integrated intelligent welding platform according to claim 1, wherein the stretching control signal comprises a first control signal; and
the stretching component comprises:
a first stretching assembly, wherein the first stretching assembly is disposed on one side of the flexible electronic skin in a second direction, and the first stretching assembly comprises a stretching actuator, a first sliding table, a second sliding table, a first clamp, and a tension-compression sensor; the stretching actuator, the first sliding table, and the second sliding table are disposed in sequence in the second direction, the first sliding table is fixedly disposed with respect to the stretching actuator, a through hole is opened on the first sliding table, a drive end of the stretching actuator passes through the through hole of the first sliding table and is connected to the second sliding table in a transmission way, the stretching actuator is electrically connected to the first control component, and the stretching actuator is configured to receive the first control signal and drive the second sliding table to move along the second direction; and the first clamp is disposed on the second sliding table, the first clamp clamps the first flexible electronic skin and the second flexible electronic skin, two detection ends of the tension-compression sensor are respectively connected to the first sliding table and the second sliding table, and the tension-compression sensor is configured to obtain tension information on the flexible electronic skin; and
a second stretching assembly, wherein the second stretching assembly and the first stretching assembly are respectively disposed at two sides of the flexible electronic skin in the second direction, the second stretching assembly comprises a second clamp, and the second clamp clamps the first flexible electronic skin and the second flexible electronic skin.

3. The integrated intelligent welding platform according to claim 2, wherein the first control component comprises:
a first comparator, wherein the first comparator is electrically connected to the flatness monitoring component, and the first comparator is configured to compare first expected flatness information with the flatness information;
a second comparator, wherein the second comparator is electrically connected to the tension-compression sensor, and the second comparator is configured to compare expected tension information with the tension information; and
a first regulator, wherein the first regulator is electrically connected to the first comparator, the second comparator, and the stretching actuator, and the first regulator transmits the first control signal based on a Proportion, Integral, and Differential (PID) control algorithm to dynamically adjust the stretching force on the flexible electronic skin, wherein
when the flatness information matches the first expected flatness information and the tension information matches the expected tension information, the first regulator transmits a first stop signal; and the stretching actuator is configured to receive the first stop signal and stop driving the second sliding table to move.

4. The integrated intelligent welding platform according to claim 3, wherein the stretching control signal comprises a second control signal;
the second clamp comprises a first clamping component and a second clamping component, the first clamping component is connected to the first flexible electronic skin, and the second clamping component is connected to the second flexible electronic skin; and
the second stretching assembly further comprises a first three-axis actuator and a second three-axis actuator that are spaced apart in sequence in the second direction; a drive end of the first three-axis actuator is connected to the first clamping component, and the first three-axis actuator is configured to receive the second control signal and drive the first clamping component to move; and a drive end of the second three-axis actuator is connected to the second clamping component, and the second three-axis actuator is configured to receive the second control signal and drive the second clamping component to move.

5. The integrated intelligent welding platform according to claim 4, wherein the first control component further comprises:
a third comparator, wherein the third comparator is electrically connected to the flatness monitoring component, and the third comparator is configured to compare second expected flatness information with the flatness information; and
a second regulator, wherein the second regulator is electrically connected to the second comparator, the third comparator, the first three-axis actuator, and the second three-axis actuator, and the second regulator is configured to transmit the second control signal to dynamically adjust the flatness information, wherein
when the flatness information matches the second expected flatness information and the tension information matches the expected tension information, the second regulator transmits a second stop signal; and the first three-axis actuator is configured to receive the second stop signal and stop driving the first clamping component to move, and the second three-axis actuator is configured to receive the second stop signal and stop driving the second clamping component to move.

6. The integrated intelligent welding platform according to claim 1, wherein the flatness monitoring component comprises:
a fringe light emitter, wherein the fringe light emitter is configured to transmit fringe light to the flexible electronic skin;
an image acquisition device, wherein the image acquisition device is configured to obtain a reflected image of the fringe light on a surface of the flexible electronic skin; and
an image processor, wherein the image processor is electrically connected to the image acquisition device and the first control component, and the image processor is configured to obtain the flatness information based on the reflected image.

7. The integrated intelligent welding platform according to claim 1, wherein the lifting component comprises two lifting assemblies, the two lifting assemblies are respectively disposed in sequence at two sides of the flexible electronic skin in a second direction, each lifting assembly comprises a compression device and two compression actuators, the two compression actuators are respectively disposed at two sides of the flexible electronic skin in a third direction, drive ends of the two compression actuators are both connected to the compression device, the compression actuators are electrically connected to the second control component, and the compression actuators are configured to receive the welding control signal and drive the compression device to move along the first direction.

8. The integrated intelligent welding platform according to claim 1, wherein the welding unit further comprises a welding component, and the welding component is configured to receive the welding control signal and weld the first flexible electronic skin and the second flexible electronic skin.

9. The integrated intelligent welding platform according to claim 1, wherein the second control component transmits the welding control signal based on an artificial neural network (ANN) model integrating a crow-wolf optimization (CWO) algorithm.

10. A welding method based on the integrated intelligent welding platform according to claim 1, comprising steps of:
S1. applying the stretching force perpendicular to the first direction to the flexible electronic skin by the stretching unit; and
S2. welding the flexible electronic skin, wherein the compression force parallel to the first direction is applied to the flexible electronic skin by the welding unit.
